(19) United States
(12) Patent Application Publication
(10) Pub. No.: US 2025/0155050 A1
(43) Pub. Date: May 15, 2025

(54) SHOWER MIXER ADAPTER

(71) Applicant: Kohler Co., Kohler, WI (US)

(72) Inventors: Shaun Skelton, Kohler, WI (US); Lilly Schroeder, Kohler, WI (US); James Giefer, Kohler, WI (US); Michael Smith, Sheboygan, WI (US); Stephanie Krickeberg, Kohler, WI (US); Thomas Sindelar, Kohler, WI (US); Keith Ruh, Elkhart Lake, WI (US); Peter Kajuch, Brookfield, WI (US); Bradley Reedy, North Aurora, IL (US); Greta Knowles, Kohler, WI (US); Chad Cochart, Kohler, WI (US)

(21) Appl. No.: 18/947,416

(22) Filed: Nov. 14, 2024

Related U.S. Application Data
(60) Provisional application No. 63/599,333, filed on Nov. 15, 2023.

(51) Int. Cl. F16K 31/60; F16K 11/00

(52) U.S. Cl. CPC F16K 31/605; F16K 19/006

(57) ABSTRACT

A mixing valve adapter is configured to connect to a plumbing fixture for controlling the mixture of two supplies of water having different temperatures. The mixing valve adapter includes at least an adapter body, a first shaft coupled to the adapter body, and a second shaft coupled to the adapter body, wherein the first shaft has a first cross-section different than a second cross-section associated with the second shaft.

### CROSS-REFERENCE TO RELATED APPLICATIONS

This application claims priority benefit of Provisional Application No. 63/599,333 (Docket No. 010222-23033A-US) filed on Nov. 15, 2023, which is hereby incorporated by reference in its entirety.

### FIELD

The present application relates to shower mixing valves and connections to water dispensing devices.

### BACKGROUND

The following embodiments relate to mixing valves, and in some instances, thermostatic mixing valves configured to blend hot water with cold water to set the output temperature of the water. Often the user manually mixes the hot and cold water to select a comfortable shower or bath outlet temperatures and avoid excessively hot or cold water.

Thermostatic mixing valves can provide a source of water having a desired temperature and can maintain the desired water temperature substantially constant once set. The desired water temperature is obtained by controlling the relative proportions of hot and cold water admitted to a mixing chamber and adjusting the relative proportions to maintain the desired water temperature substantially constant.

### BRIEF DESCRIPTION OF THE DRAWINGS

Exemplary embodiments are described herein with reference to the following drawings, according to an exemplary embodiment.

FIG. 1 illustrates an example mixing valve.

FIG. 2A illustrates an example mixing valve including an adapter.

FIG. 2B illustrates example shapes for the adapter.

FIG. 2C illustrates an example interchangeable bit for the adapter.

FIG. 3 illustrates an example shower installation.

FIG. 4 illustrates an example placement of the adapter and mixing valve in the example shower installation.

FIG. 5 illustrates another example shower adapter.

FIG. 6 illustrates a rear side of the shower adapter of FIG. 5.

FIG. 7 illustrates a control system for an automated mixing valve.

FIG. 8 illustrates a flow chart for installation of the shower panel assembly.

### DETAILED DESCRIPTION

The following embodiments includes a mixing valve adapter that is configured to convert physical connections of a first type (e.g., first manufacturer) to be coupled to physical connections of a second type (e.g., second manufacturer).

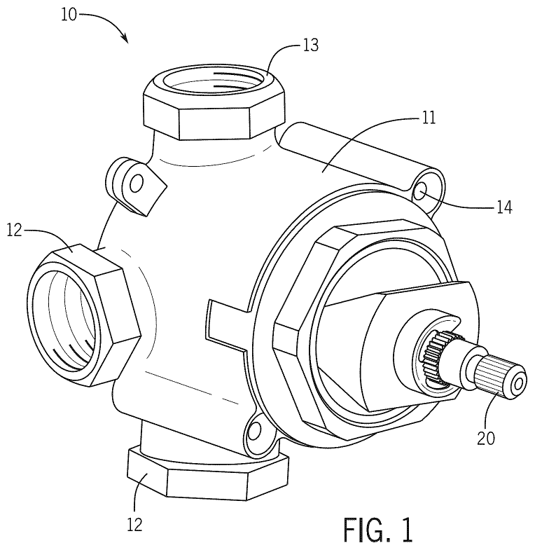

FIG. 1 illustrates an example mixing valve 10 for a plumbing fixture for controlling the mixture of two supplies of water having different temperatures. The mixing valve 10 includes one or more water inlets 12 and a water outlet 13. The mixing valve 10 may be formed of a singular body 11, which may be copper or brass. The mixing valve 10 internally mixes (e.g., via an internal valve member) varying proportions of hot and cold water from inlets 12, which is provided to water outlet 13. The proportion of hot and cold water may be determined by a rotational position of input shaft 20, which may be connected to a handle or lever. The internal valve member may simultaneously partially open the cold side inlet and partially close the hot side inlet as the input shaft is rotated another direction (e.g., counterclockwise).

As shown in FIG. 1, the input shaft 20 has a proprietary shape so that only a handle or lever with a matching (e.g., inverse) shape can fit onto the input shaft 20. That is, the input shaft 20 includes a male connector having one or more sides or ridges that mate with a female connector on the handle or lever. In some instances, a particular manufacturer provides the proprietary shape on the mixing valve 10 so that only handles, levers, or other user devices from the same manufacturer are compatible. The following embodiments include adapters configured to made mixing valves from any manufacturer to handle, levers, or other user devices from any other manufacturer.

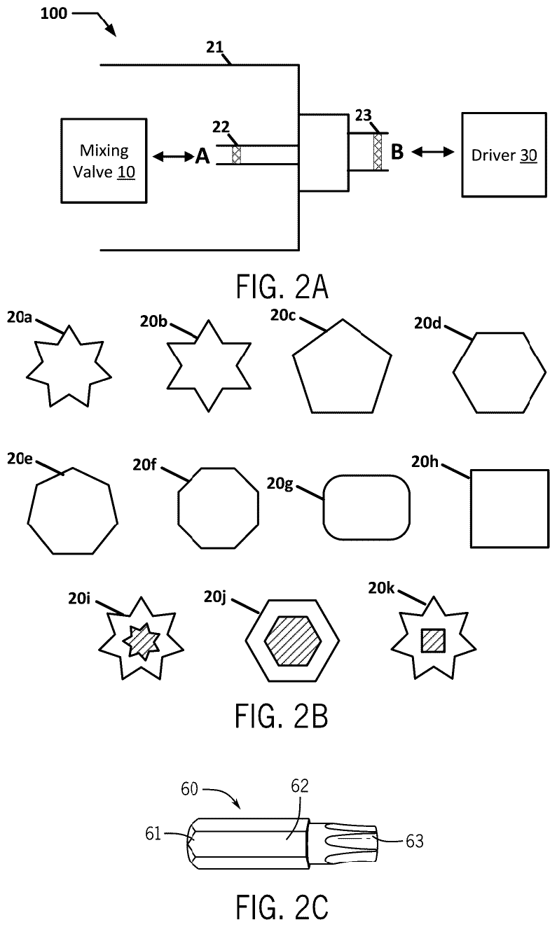

FIG. 2 illustrates an example mixer adaptor 100 to convert from the proprietary shape of one manufacturer to the proprietary shape of another manufacturer. The mixer adapter 100 may include an adapter body 21 including a driver side A adapted to couple with the mixing valve 10 and a driven side B adapted to couple with a driver 30 such as a handle, a lever, or a motor. The driver side A has a mating device 22 that meshes or otherwise couples with the mixing valve 10. Example shapes for the mating device 22 are illustrated in FIG. 2B. The driven side B has a mating device 23 that meshes or otherwise couples with the driver. Example shapes for the mating device 23 are illustrated in FIG. 2B.

As shown in FIG. 2B, various shapes for the cross section of the mating device 22 and the mating device 23 include, but are not limited to a triangle shape, a star shape (e.g., seven point star 20a or six point star 20b), a pentagon shape 20c, a hexagon shape 20d, a heptagon shape 20e, an octagon shape 20f, a rounded rectangle 20g, a square or other rectangle 20h, or other solid shape. Each of the shapes includes at least two angles and at least three sides that abut against the mixing valve 10 or the driver 30 in order to transfer a rotational force or torque through the adapter body 21. Example hollow shapes for the mating device 22 and the mating device 23 may include a solid outer surface and solid inner surface with a hollow core, as shown by hollow star 20i and hollow hexagon 20k. In some examples, the hollow shape is different than the outer shape, as shown by mating device 22k with an outer star and an inner hollow square. The mating device 22 may couple with the mixing valve 10 by contacting both the solid out surface and the solid inner surface. The mating device 23 may couple with the driver 30 by contacting both the solid out surface and the solid inner surface.

The adapter 100 may include interchangeable parts for the mating device 22 and mating device 23. In this way, any shape for the cross-section of the mating device 22 and mating device 23 may be interchanged (i.e., one shape removed from the adapter 100 and another shape added to the adapter 100). In this way, the adapter 100 may be considered a universal adapter operable with any manufacturer and any shape of connector.

In other words, a part or component may be added to the mating device 22 to change the cross-sectional shape that is outward facing for the adapter 100. Likewise, a part or component may be added to the mating device 23 to change the cross-sectional shape that is outward facing for the adapter 100. For example, when the mating device 22 includes a star shape 20a, a cap may be placed over the shaft to change the cross-section shape to a rectangle 20h. When the mating device 22 already includes a cap in the shape of the rectangle 20h, the cap may be removed to reveal the star shape 20a. Other structures, such as sleeves, may be used for any combination of shapes. This is one example of how the adapter 100 may be implemented in shapes that is universal to all manufacturers of mixing valves and accessories therefor.

In one example, the adapter 100 is configured to define shapes for the mating device 22 and the mating device 23 using an interchangeable bit. For example, FIG. 2C illustrates a bit 60 include a base end 61, a trunk 62, and an outward end 63. The outward end 63 defines the shapes described above for the mating device 22 and/or the mating device 23. In this way the adapter 100 may be configured with (e.g., sold with in a kit or package) with multiple bits 60 having different shapes for the outward end 63. Each of the bits 60 have a standard shape for the base end 61 (e.g., hexagon is shown in FIG. 2C for the base end 61). A user may remove one bit 60 having one shape for the outward end 63 and replace it with another bit 60 having another shape for the outward end 63. This is one example of how the adapter 100 may be implemented in shapes that is universal to all manufacturers of mixing valves and accessories therefor.

The mating device 22 may have a cross sectional shape associated with a first manufacturer and the mating device 23 may have a cross sectional shape associated with a second manufacturer. In this way, a driver 30 from a first manufacturer can be coupled to a mixing valve 10 of a second manufacturer.

When the driver 30 is a motor, the motor may be connected to a controller that provides commands to the motor. A remote control, a keypad, a touchscreen, or other input device may instruct the controller how to operate the motor to rotate the driver 30, and accordingly, the adapter 100 and the mixing valve 10 under rotational forces from the driver 30.

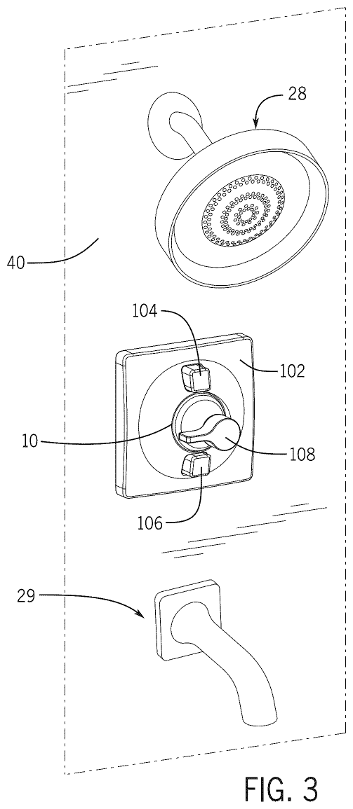

FIG. 3 illustrates an example shower installation including the mixing valve 10 and adapter body 21. In this example, the driver 30 is illustrated as a handle 108. When the user manually rotates the handle 108, or another actuator turns the valve, a flow of water starts. The flow of water may flow through a tub spout 29 as the primary outlet in the system. If a user wishes to divert the flow of water to, for example, an overhead shower 28, the user may manually lift a diverter pin or press a corresponding button 104.

Further the handle 108 allows a user to set an approximate water temperature range by turning the handle 108 to start a flow of water, and then selectively actuate one of a first push button 104 associated with the shower 28 to divert the flow of water to the shower or a second push button 106 associated with a tub spout 29 to divert the flow of water to the tub. The first and second push buttons 104, 106 are each operatively coupled to separate flow control valves located in close proximity to each other. The system further includes a mixing valve 10 (e.g., a sequential valve, etc.) that is operatively coupled to the handle 108 to control the water temperature for both the shower 28 and the tub spout 29 in the same general location. The first push button 104 and the second push button 106 may be located in the same approximate area as the flow control handle 108, such as on the same trim piece or escutcheon 102, so as to help avoid the need for a user to have to bend over to manually pull a diverter pin on the tub spout (e.g., diverter pin, etc.) to divert the flow, as is the case with most conventional tub and shower diverters.

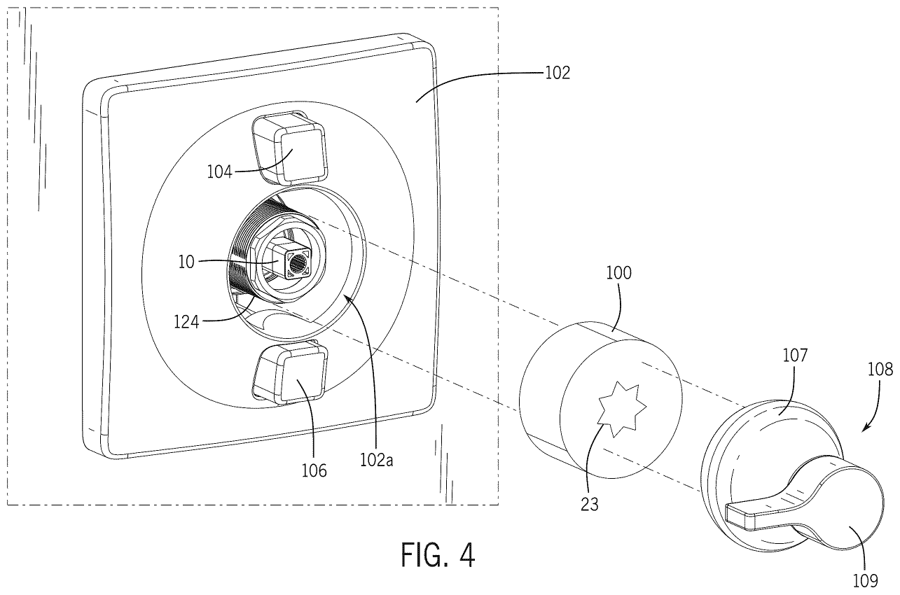

FIG. 4 illustrates an example placement of the adapter 100 and mixing valve 10 in the example shower installation. The diverter assembly may include an escutcheon 102 (e.g., trim piece, etc.) for retaining the first and second push button assemblies 104, 106 and for providing an external user interface on, for example, a wall in a shower environment (e.g., shower wall 40, etc.). The escutcheon 102 includes a central opening 102a for receiving at least a portion of the handle assembly 108 therethrough. The handle assembly 108 is collectively defined by a base 107 and a handle 109. The handle assembly 108 is configured to be detachably coupled to the valve nut 124, so as to rotatably couple the handle assembly 108 to the adapter 100 via mating device 23, which is connected to the mixing valve 10 (e.g., via mating device 22) to allow for a user to manually operate the mixing valve 10 to control water temperature.

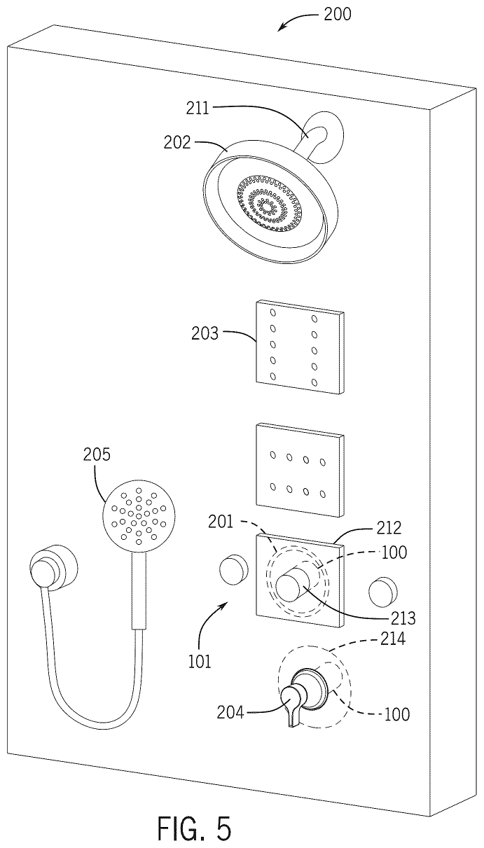

FIG. 5 illustrates another example shower adapter. A shower panel assembly 200 includes a showerhead 202 connected to the shower panel assembly 200 by arm 211, a body sprayer 203, a handshower 205 and one or more other water dispensing devices. The shower panel assembly 200 may also include one or more outlet selectors 101, which may be a single knob with multiple settings (e.g., any one or combination of showerhead 202, body sprayer 203, and handshower 205). The shower panel assembly 200 may also include a handle 204 connected to adapter 100 for turning a mixing valve 214 to set the temperature of the dispensed water. The adapter 100 may be any of the examples described herein.

In addition, a second mixing valve and adapter may be included in the shower panel assembly. The second mixing valve, illustrated as mixing valve 201, may be a diverter that diverts the flow of water to various outlets (e.g., arm 211, body sprayer 203, handshower 205) individually or in any combination. As shown, the diverter is part of an outlet selector 101 including a rotatable knob that is connected to a valve using the adapter 100. The mixing valve 201 may be connected to a handle 213 and mounted behind a trim plate 212. However, multiple knobs or dials may be used. The mixing valve 201 may be connected to the handle 213 via another adapter 100. Thus, the shower panel assembly 200 includes multiple adapters 100 for multiple mixing valves.

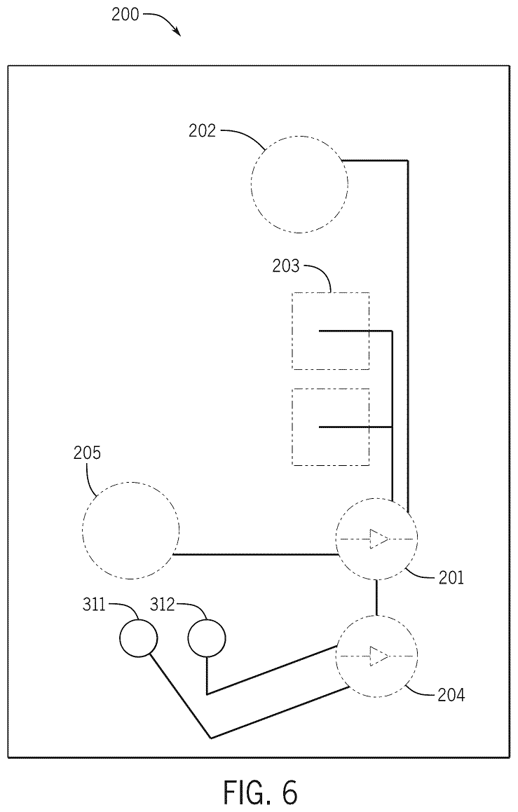

FIG. 6 illustrates a rear side of the shower adapter of FIG. 5. The shower panel assembly 200 include one or more internal water passages or pipes that connect any one or combination of showerhead 202, body sprayer 203, and handshower 205 to the mixing valve 201. In addition, one or more internal water passages or pipes connect the shower panel assembly 200 to a cold water input 311 and a hot water input 312.

The escutcheon (e.g., trim piece) for the outlet selector 101 and/or handle 204 may include one or more fasteners that extends through the shower panel assembly 200 and into the wall. In addition, the shower panel assembly 200 may include one or more other fasteners that secure the shower panel assembly 200 to the wall.

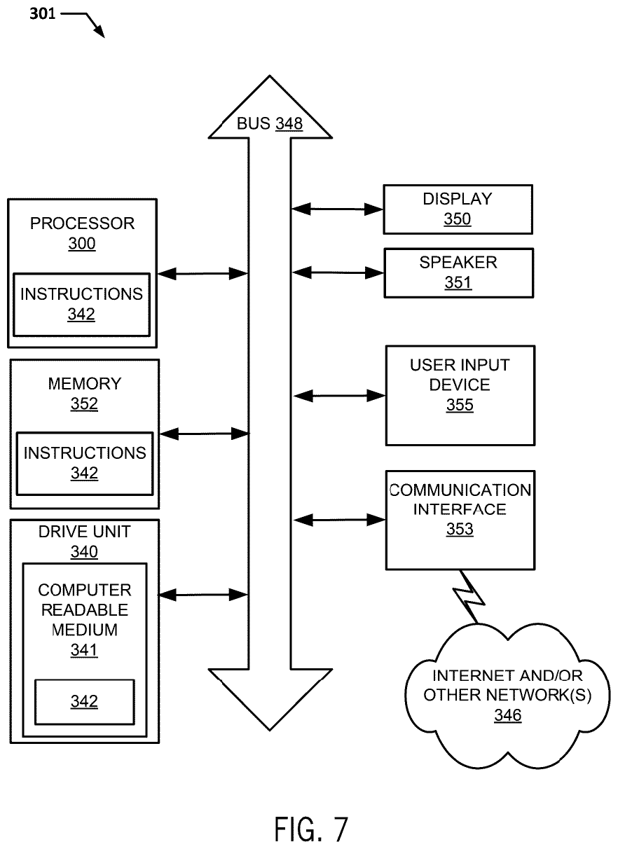

FIG. 7 illustrates an example control system or controller 301 for any of the embodiments described herein. In one example, the controller 301 may control a motor for rotating the adapter 100 to operate the mixing valve 10. The controller 301 may include a processor 300, a memory 352, and a communication interface 353 for interfacing with devices or to the internet and/or other networks 346. In addition to the communication interface 353, a sensor interface may be configured to receive data from the sensors described herein or data from any source. The controller 301 may include an integrated display 350 (projector), speaker 351, or other output devices. The components of the control system may communicate using bus 348. The control system may be connected to a workstation or another external device (e.g., control panel) and/or a database for receiving user inputs, system characteristics, and any of the values described herein.

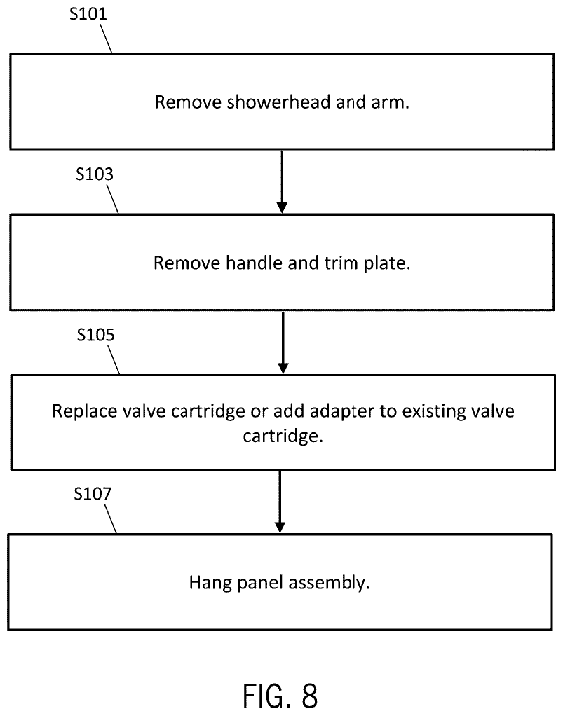

FIG. 8 includes a flow chart for installation of the shower panel assembly 200 in a retrofit installation. It should be noted that in a new construction installation, the shower panel assembly 200 is aligned with the utility supply lines and secured to the wall.

At act S101, the showerhead 202 and arm 211 are removed.

At act S103, the handle 213 (e.g., first water supply valve handle) is removed from a mixer valve or valve cartridge. In addition, the trim plate 212 may be removed. Water may be shutoff before or after acts S101 and S103.

At act S105, the mixer valve or valve cartridge is removed and replaced with a new mixer valve or valve cartridge having the adapter 100 described herein. In many instances, the adapter 100 may be installed onto the existing mixer valve or valve cartridge. In either example, the adapter 100 is connected to the mixer valve. A new handle, knob, dial, or other device may be connected to the adapter 100. For example, in one example, a second water supply valve handle is connected to the adapter 100.

At act S107, the panel assembly 200 is hanged on the existing wall. The panel assembly 200 includes the mixer valve and the second water supply valve handle. The shower panel assembly 200 goes over existing wall and replaces existing valve and trim. The shower panel assembly 200 may be attached directly to the wall. The installation may require cutting into wall to remove existing valve and connecting to supplies. In some examples, the panel assembly 200 is pre-plumbed with fitting options (bath spout, body spray, showerhead, etc.). The panel assembly 200 may include quick connectors to old valve outlets. In other examples, the previous showerhead and handle may be attached to the panel assembly 200.

In some examples, the shower panel assembly 200 may include one or more structures or devices for storage, music, or lighting. The control system 301 may generate and send commands to a speaker for music. The control system 301 may generate and send commands to a light (e.g., LED) for lighting or illuminated indicators.

Optionally, the control system may include an input device 355 and/or a sensing circuit 356 in communication with any of the sensors. The sensing circuit receives sensor measurements from sensors as described above. The input device may include any of the user inputs such as buttons, touchscreen, a keyboard, a microphone for voice inputs, a camera for gesture inputs, and/or another mechanism.

Optionally, the control system may include a drive unit 340 for receiving and reading non-transitory computer media 341 having instructions 342. Additional, different, or fewer components may be included. The processor 300 is configured to perform instructions 342 stored in memory 352 for executing the algorithms described herein. A display 350 may be an indicator or other screen output device. The display 350 may be combined with the user input device 355.

Processor 300 may be a general purpose or specific purpose processor, an application specific integrated circuit (ASIC), one or more programmable logic controllers (PLCs), one or more field programmable gate arrays (FPGAs), a group of processing components, or other suitable processing components. Processor 300 is configured to execute computer code or instructions stored in memory 352 or received from other computer readable media (e.g., embedded flash memory, local hard disk storage, local ROM, network storage, a remote server, etc.). The processor 300 may be a single device or combinations of devices, such as associated with a network, distributed processing, or cloud computing.

Memory 352 may include one or more devices (e.g., memory units, memory devices, storage devices, etc.) for storing data and/or computer code for completing and/or facilitating the various processes described in the present disclosure. Memory 352 may include random access memory (RAM), read-only memory (ROM), hard drive storage, temporary storage, non-volatile memory, flash memory, optical memory, or any other suitable memory for storing software objects and/or computer instructions. Memory 352 may include database components, object code components, script components, or any other type of information structure for supporting the various activities and information structures described in the present disclosure. Memory 352 may be communicably connected to processor 300 via a processing circuit and may include computer code for executing (e.g., by processor 300) one or more processes described herein. For example, the memory 352 may include graphics, web pages, HTML files, XML files, script code, shower configuration files, or other resources for use in generating graphical user interfaces for display and/or for use in interpreting user interface inputs to make command, control, or communication decisions.

In addition to ingress ports and egress ports, the communication interface 353 may include any operable connection. An operable connection may be one in which signals, physical communications, and/or logical communications may be sent and/or received. An operable connection may include a physical interface, an electrical interface, and/or a data interface. The communication interface 353 may be connected to a network. The network may include wired networks (e.g., Ethernet), wireless networks, or combinations thereof. The wireless network may be a cellular telephone network, an 802.11, 802.16, 802.20, or WiMax network, a Bluetooth pairing of devices, or a Bluetooth mesh network. Further, the network may be a public network, such as the Internet, a private network, such as an intranet, or combinations thereof, and may utilize a variety of networking protocols now available or later developed including, but not limited to TCP/IP based networking protocols.

While the computer-readable medium (e.g., memory 352) is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. The computer-readable medium may be non-transitory, which includes all tangible computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A mixing valve adapter for a plumbing fixture for controlling a mixture of two supplies of water having different temperatures, the mixing valve adapter comprising:
an adapter body;
a first shaft coupled to the adapter body; and
a second shaft coupled to the adapter body, wherein the first shaft has a first cross-section different than a second cross-section associated with the second shaft.

2. The mixing valve adapter of claim 1, wherein the first cross-section corresponds to a first manufacturer and the second cross-section corresponds to a second manufacturer.

3. The mixing valve adapter of claim 1, wherein the first shaft is interchangeable so that the first cross-section can be changed through an addition or removal of a bit.

4. The mixing valve adapter of claim 1, wherein the first shaft is coupled to a handle.

5. The mixing valve adapter of claim 4, wherein the first cross-section of the first shaft has a hollow section configured to mate with the handle.

6. The mixing valve adapter of claim 1, wherein the second shaft is coupled to a mixing valve.

7. The mixing valve adapter of claim 1, wherein the first cross-section of the first shaft has a star shape, a square shape, a rectangular shape, a hexagonal shape, a heptagonal shape, or an octagonal shape.

8. The mixing valve adapter of claim 1, wherein the second cross-section of the second shaft has a star shape, a square shape, a rectangular shape, a hexagonal shape, a heptagonal shape, or an octagonal shape.

9. A shower panel comprising:
a plurality of water dispensing outlets;
a mixing valve;
a plurality of pipes connecting the mixing valve to the plurality of water dispensing outlets;
a handle configured to operate the mixing valve; and
a mixing valve adapter connected to the mixing valve and the handle, the mixing valve adapter comprising:
an adapter body;
a first shaft coupled to the adapter body; and
a second shaft coupled to the adapter body, wherein the first shaft has a different cross-section than the second shaft.

10. The shower panel of claim 9, wherein the first shaft is coupled to a handle.

11. The shower panel of claim 9, wherein the second shaft is coupled to a mixing valve.

12. The shower panel of claim 9, wherein the cross-section of the first shaft has a star shape, a square shape, a rectangular shape, a hexagonal shape, a heptagonal shape, or an octagonal shape.

13. The shower panel of claim 9, wherein the cross-section of the second shaft has a star shape, a square shape, a rectangular shape, a hexagonal shape, a heptagonal shape, or an octagonal shape.

14. The shower panel of claim 9, wherein the cross-section of the first shaft has a hollow section configured to mate with the handle.

15. The shower panel of claim 9, wherein the cross-section of the first shaft corresponds to a first manufacturer and the cross-section of the second shaft corresponds to a second manufacturer.

16. The shower panel of claim 9, wherein the first shaft is interchangeable so that the cross-section can be changed through an addition or removal of a bit.

17. The shower panel of claim 9, wherein the mixing valve adapter is a first mixing valve adapter, and the mixing valve is a first mixing valve for temperature selection, the shower panel further comprising:
a second mixing valve for outlet selection; and
a second mixing valve adapter coupled to the second mixing valve.

18. A method for installation of a shower panel, the method comprising:
removing a first water supply valve handle from a mixer valve;
connecting an adapter to the mixer valve; and
connecting a second water supply valve handle to the adapter.

19. The method of claim 18, further comprising:
removing the mixer valve after the first water supply valve handle is removed; and
installing a replacement mixer valve.

20. The method of claim 18, further comprising:
hanging a panel assembly including mixer valve and the second water supply valve handle.
